(19) United States
(12) Patent Application Publication
(10) Pub. No.: US 2009/0207421 A1
(43) Pub. Date: Aug. 20, 2009

(54) Laser 3-Point Distance and Angle Calculator

(76) Inventors: Alphonse Kelly, Acworth, GA (US); Allan Grant, Kennesaw, GA (US); Saudia Kelly, Acworth, GA (US); Leroy Gunning, Deland, FL (US)

Correspondence Address: Alphonse Kelly, 3365 McEver Park Cir, Acworth, GA, 30101-6651, US

(21) Appl. No.: 12/019,613

(22) Filed: Jan. 24, 2008

Related U.S. Application Data
(60) Provisional application No. 61/000,273, filed on Oct. 25, 2007.

(51) Int. Cl. G01B 11/14

(52) U.S. Cl. 356/614

(57) ABSTRACT

A laser distance and angle calculator that will give three measured distances simultaneously; for example from Point A to B, Point A to C and Point B to C. It will also calculate the angle at each intersecting points. The angle at your point of reference is required, but the other angles are calculated.

The laser control is used to rotate the corresponding laser. As each laser is pointed to their respective targets, the distances to these are captured. The lasers are optionally placed adjacent to each other or one above the other. The angle between these two points are also captured. With these pieces of captured data, the distance between the two targets along with the angles formed by this triangular formation will be calculated. This data will then be displayed on the LCD. This data can be cleared and the process repeated as often as desired.

### RELATED APPLICATIONS

The present application is related to U.S. Pat. No. 6,100,0273, filed Oct. 25, 2007, included by reference herein.

### FIELD OF THE INVENTION

The present invention relates to laser tape measurers and, more particularly, to laser tape measurers that can measure multiple values simultaneously.

### BACKGROUND OF THE INVENTION

Have you ever had the need to measure the height of a building, a pole, a tree, etc; or the distance between two points, both of which are some distance away from you? Maybe you are a builder and you are on the roof of your two-story house replacing some rafters. The piece of lumber beside you is eight feet (8′) long, but you need a piece that is seven feet (7′) long. You then noticed there are a couple of pieces of lumber on the ground; should you cut a foot (1′) off the piece you have (knowing that you'll need a piece eight feet (8′) long soon) or should you climb all the way down to the ground and measure the pieces there? You may climb all the way down only to find out that one measures 7′ 11″ and the other 8′ 1′. Now you discovered that you should have stayed up on the roof, and use the piece you had. Maybe you have been contracted to run a drain pipe all the way down the side of a 20-story building. Do you like others go to the top of the building, drop a line and then measure the line? These are real and challenging problem many have.

My problem is this: through the back of my yard run the City's utility poles. My concern is whether or not the pole nearest to my house will hit the house if it breaks away at it's base. It seems so to me. It's my desire to solve this problem that has resulted in this invention.

To date my research has yielded no product(s) which has attempted to solve any of the problems listed above.

Conventional laser tape measurers will only measure the distance from your point of origin to another single point.

It is therefore an object of the invention to provide the capability to measure the distance between two distant objects/targets.

It is another object of the invention to measure the height of most objects, while aloof.

It is another object of the invention to simultaneously measure the distance from your point of reference to two (2) separate objects.

It is another object of the invention to simultaneously measure the combined distance from your point of reference to target 1, from target 1 to target 2, from target 2 back to your point of reference.

It is another object of the invention to calculate any/all of the three angles created from your point of reference and the other two targets.

### SUMMARY OF THE INVENTION

In accordance with the present invention, there is provided a laser distance and angle calculator that will give three measured distances simultaneously; for example from Point A to B, Point A to C and Point B to C. It will also calculate the angle at each intersecting points. The angle at your point of reference is required, while the other angles are results of the calculation.

As the laser control is turned on each side of the instrument, the corresponding laser rotates accordingly. As the laser on each side is pointed to their respective targets, the distances to these are captured. The lasers are optionally placed adjacent to each other or one above the other. The angle between these two points are also captured. With these pieces of captured data, the following calculation will be done:
(a) the distance between the two targets
(b) the angle formed from
   (i) the Point of origin to Target #1 to target #2
   (ii) the Point of origin to Target #2 to target #1

This data will then be displayed on the LCD. This data can be cleared and the process repeated as often as desired.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a two lasers on a small head view of a 3-point laser distance and angle calculator showing the instruments with two adjacent laser beams;

FIG. 2 is a two lasers on a large head view of a 3-point laser distance and angle calculator showing the instrument with two adjacent laser beams;

FIG. 3 is an one or two lasers on a small head view of a 3-point laser distance and angle calculator showing the lasers, having the capability of rotating 180 degrees;

FIG. 4 is an one or two lasers on a large head view of a 3-point laser distance and angle calculator showing one laser, having the capability of rotating 180 degrees;

FIG. 5 is a front-head rotated 90 degrees to the left view of a 3-point laser distance and angle calculator showing head with two (2) lasers atop each other, rotated to the left;

FIG. 6 is a front-head rotated 90 degrees to the right view of a 3-point laser distance and angle calculator showing head with two (2) lasers adjacent to each other, rotated to the left;

FIG. 7 is a front-one laser-head rotated to the right view of a 3-point laser distance and angle calculator showing head with one (1)) laser, rotated 90 degrees to the right; and

FIG. 8 is a laser triangle view of a showing the triangular path of the laser 3-point distance and angle calculator.

For purposes of clarity and brevity, like elements and components will bear the same designations and numbering throughout the Figures.

### DESCRIPTION OF THE PREFERRED EMBODIMENT

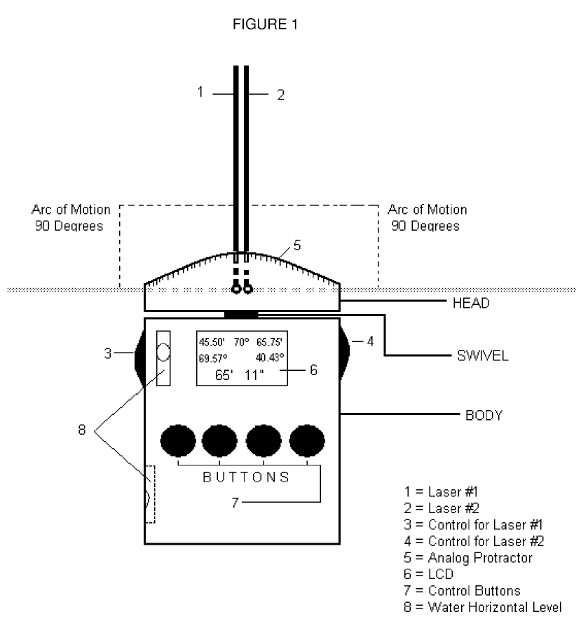

FIG. 1 is a two lasers on a small head (12) view, showing the Laser (16) 3-Point Distance and Angle Calculators with two adjacent laser (16) beams.

### Head

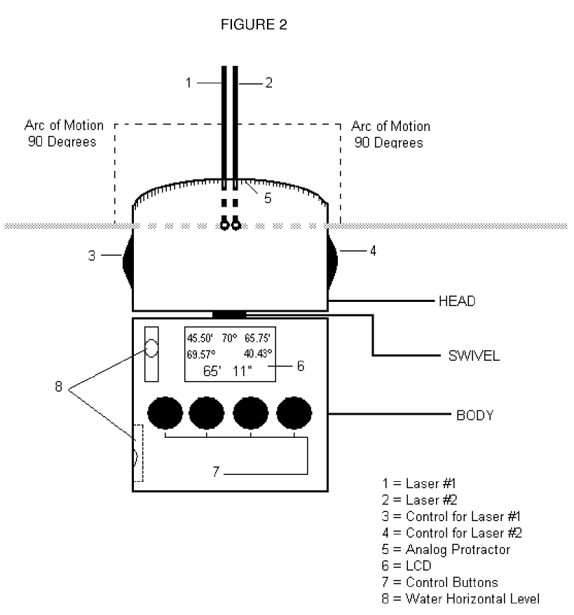

The head (12) is the compartment designed to house the lasers and optionally their controls. (FIG. 2 shows the controls placed on the head (12) instead of the body (14).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles.

### Analog Protractor

The optional Analog Protractor (26) will provide an approximate visual reading of the location of the lasers. It must be noted the laser (16) would have already been digitally calibrated in degrees; and decimal fractions of such.

### Swivel

The swivel (18) connects the head (12) to the body (14). It also allows the head (12) to rotate in either direction up to a vertical position (90 degrees).

### Body

The body (14) is the compartment designed to house all the other components not placed on or in the head (12). This figure shows the Laser (16) Controls, LCD (22) and Control buttons (24). Other obvious components like microcomputer, power supply etc, although not shown, will be housed here also.

### Laser

The laser (16) is one of the key components of this Laser (16) 3-Point Distance and Angle Calculator. This figure shows the two (2) lasers placed adjacent to each other. These lasers will in some instances be placed one above the other, a decision which will be optional to a manufacturer. The laser (16) on the left is able rotate from its leftward-pointing horizontal position, through an arc of 90 degrees, up to the vertical position. The laser (16) on the right is able rotate from its rightward-pointing horizontal position, through an arc of 90 degrees, up to the vertical position. Each laser (16) may be configured to rotate from 0-180 degrees. The same result will/can be achieved in either case.

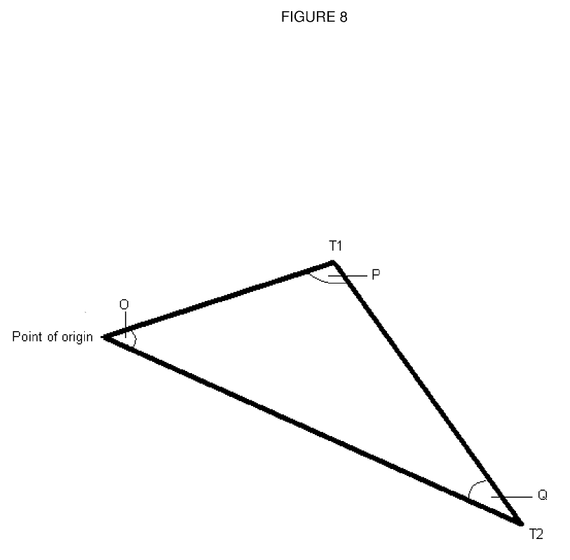

The function of the lasers are as follows:
(1) The [left Laser (16)] (LL) is rotated (using the left Laser Control (20)) Along a calibrated degree scale, and pointed on target number 1 (T1). The degree reading along with the distance to T1 is captured and stored by the Laser (16) 3-Point Distance and Angle Calculator's computing component.
(2) The [right Laser (16)] (RL) is rotated (using the right Laser Control (20)) along a calibrated degree scale, and pointed on target number 2 (T2). The degree reading along with the distance to T2 is captured and stored by the Laser (16) 3-Point Distance and Angle Calculator's computing component.
(3) The angle between T1 and T2 is also captured. For the purpose of this document, this angle is referred to as “O” (see FIG. 8). If each laser (16) is made to rotate through an arc of 180 degrees; and, the degree reading for the left laser (16) is greater than that of the right laser (16), then the absolute value for the difference in these two readings will be used in the calculation.
(4) The captured data is then be manipulated and the follow results will be displayed on the LCD (22):
   (a) The distance from your point of origin to T1 (already captured in step #1 above).
   (b) The distance from your point of origin to T2 (already captured in step #2 above).
   (c) The angle at your point of origin between T1 and T2 (already captured in step #3 above).
   (d) The distance between T1 and T2.
   (e) The angle created from your point of origin, to T1 and then to T2. For the purpose of this document, this angle is referred to as “P” (see FIG. 8).
   (f) The angle created from your point of origin, to T2 and then to T1. For the purpose of this document, this angle is referred to as “Q” (see FIG. 8).
   (g) The total distance (perimeter) from point O to T1 to T2.

### Laser Control

The right Laser Control (20) is used to rotate its respective laser (16) through its capable arc.

The left Laser Control (20) is used to rotate its respective laser (16) through its capable arc.

### Horizontal Water Level

The Horizontal Water Level (28) is use to determine when the instrument is in a horizontal position. These are placed on both the top and side of the instrument to be utilized at the user's discretion.

### LCD

The LCD (22) will be used to display any or all of the data realized in step #4. Any other relevant information (like power level) may also be displayed here.

### Control Buttons

The control buttons (24) are reserved for whatever functions the manufacturer deems necessary. Any or all of these buttons may be used. Additional buttons may be added as needed.

FIG. 2 is a two lasers (16) on a large head (12) view, showing the Laser (16) 3-Point Distance and Angle Calculator's with two adjacent laser (16) beams.

### Head

The head (12) is the compartment designed to house the lasers and optionally their controls. (FIG. 1 shows the controls placed on the body (14) instead of the head (12).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles.

### Analog Protractor

The optional Analog Protractor (26) will provide an approximate visual reading of the location of the lasers. It must be noted the laser (16) would have already been digitally calibrated in degrees and decimal fractions of such.

### Swivel

The swivel (18) connects the head (12) to the body (14). It also allows the head (12) to rotate in either direction up to a vertical position (90 degrees).

### Body

The body (14) is the compartment designed to house all the other components not placed on or in the head (12). This figure shows the Laser (16) Controls, LCD (22) and Control buttons (24). Other obvious components like microcomputer, power supply etc, although not shown, will be housed here also.

### Laser

The laser (16) is one of the key components of this Laser (16) 3-Point Distance and Angle Calculator. This figure shows the two (2) lasers placed adjacent to each other. These lasers will in some instances be placed one above the other, a decision which will optional to a manufacturer. The laser (16) on the left is able rotate from its leftward-pointing horizontal position, through an arc of 90 degrees, up to the vertical position. The laser (16) on the right is able rotate from its rightward-pointing horizontal position, through an arc of 90 degrees, up to the vertical position. Each laser (16) may be configured to rotate from 0-180 degrees. The same result will/can be achieved in either case.

The function of the lasers are as follows:
(1) The [left Laser (16)] (LL) is rotated (using the left Laser Control (20)) along a calibrated degree scale, and pointed on target number 1 (T1). The degree reading along with the distance to T1 is captured and stored by the Laser (16) 3-Point Distance and Angle Calculator's computing component.
(2) The [right Laser (16)] (RL) is rotated (using the right Laser Control (20)) along a calibrated degree scale, and pointed on target number 1 (T2). The degree reading along with the distance to T2 is captured and stored by the Laser (16) 3-Point Distance and Angle Calculator's computing component.
(3) The angle between T1 and T2 is also captured. For the purpose of this document, this angle is referred to as “O” see FIG. 8). If each laser (16) is made to rotate through an arc of 180 degrees; and, the degree reading for the left laser (16) is greater than that of the right laser (16), then the absolute value for the difference in these two readings will be used in the calculation.
(4) The captured data is then be manipulated and the follow results will be displayed on the LCD (22):
   (a) The distance from your point of origin to T1 (already captured in step #1 above).
   (b) The distance from your point of origin to T2 (already captured in step #2 above).
   (c) The angle at your point of origin between T1 and T2 (already captured in step #3 above).
   (d) The distance between T1 and T2.
   (e) The angle created from your point of origin, to T1 and then to T2. For the purpose of this document, this angle is referred to as “P” (see FIG. 8).
   (f) The angle created from your point of origin, to T2 and then to T1. For the purpose of this document, this angle is referred to as “Q” (see FIG. 8).
   (g) The total distance (perimeter) from point O to T1 to T2.

### Laser Control

The right Laser Control (20) is used to rotate its respective laser (16) through its capable arc.

The left Laser Control (20) is used to rotate its respective laser (16) through its capable arc.

### Horizontal Water Level

The Horizontal Water Level (28) is use to determine when the instrument is in a horizontal position. These are placed on both the top and side of the instrument to be utilized at the user's discretion.

### LCD

The LCD (22) will be used to display any or all of the data realized in step #4. Any other relevant information (like power level) may also be displayed here.

### Control Buttons

These are reserved for whatever functions the manufacturer deems necessary. Any or all of these buttons may be used. Additional buttons may be added as needed.

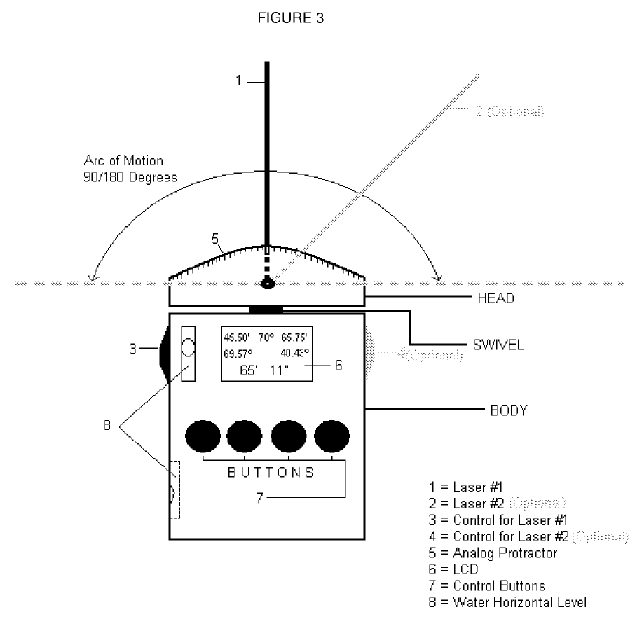

FIG. 3 is a one or two laser(s) (16) on a small head (12), showing them having the capability of rotating 180 degrees.

### Head

The head (12) is the compartment designed to house the lasers and optionally their controls. (FIG. 2 shows the controls placed on the head (12) instead of the body (14).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles.

### Analog Protractor

The optional Analog Protractor (26) will provide an approximate visual reading of the location of the lasers. It must be noted the laser (16) would have already been digitally calibrated in degrees and decimal fractions of such.

### Swivel

The swivel (18) connects the head (12) to the body (14). It also allows the head (12) to rotate in either direction up to a vertical position (90 degrees).

### Body

The body (14) is the compartment designed to house all the other components not placed on or in the head (12). This figure shows the Laser (16) Controls, LCD (22) and Control buttons (24). Other obvious components like microcomputer, power supply etc, although not shown, will be housed here also.

### Laser

The laser (16) is one of the key components of this Laser (16) 3-Point Distance and Angle Calculator. This figure shows the two (2) lasers placed adjacent to each other. These lasers will in some instances be placed one above the other, a decision which will optional to a manufacturer. The laser (16) on the left is able rotate from its leftward-pointing horizontal position, through an arc of 90 degrees, up to the vertical position. The laser (16) on the right is able rotate from its rightward-pointing horizontal position, through an arc of 90 degrees, up to the vertical position. Each laser (16) may be configured to rotate from 0-180 degrees. The same result will/can be achieved in either case.

The function of the lasers are as follows:
(1) The [left Laser (16)] (LL) is rotated (using the left Laser Control (20)) along a calibrated degree scale, and pointed on target number 1 (T1). The degree reading along with the distance to T1 is captured and stored by the Laser (16) 3-Point Distance and Angle Calculator's computing component.
(2) The [right Laser (16)] (RL) is rotated (using the right Laser Control (20)) along a calibrated degree scale, and pointed on target number 1 (T2). The degree reading along with the distance to T2 is captured and stored by the Laser (16) 3-Point Distance and Angle Calculator's computing component.
(3) The angle between T1 and T2 is also captured. For the purpose of this document, this angle is referred to as “O” (see FIG. 8). If each laser (16) is made to rotate through an arc of 180 degrees; and, the degree reading for the left laser (16) is greater than that of the right laser (16), then the absolute value for the difference in these two readings will be used in the calculation.
(4) The captured data is then be manipulated and the follow results will be displayed on the LCD (22):
   (a) The distance from your point of origin to T1 (already captured in step #1 above).
   (b) The distance from your point of origin to T2 (already captured in step #2 above).
   (c) The angle at your point of origin between T1 and T2 (already captured in step #3 above).
   (d) The distance between T1 and T2.
   (e) The angle created from your point of origin, to T1 and then to T2. For the purpose of this document, this angle is referred to as “P” (see FIG. 8).
   (f) The angle created from your point of origin, to T2 and then to T1. For the purpose of this document, this angle is referred to as “Q” (see FIG. 8).
   (g) The total distance (perimeter) from point O to T1 to T2.

### Laser Control

The right Laser Control (20) is used to rotate its respective laser 16) through its capable arc.

The left Laser Control (20) is used to rotate its respective laser (16) through its capable arc.

### Horizontal Water Level

The Horizontal Water Level (28) is use to determine when the instrument is in a horizontal position. These are placed on both the top and side of the instrument to be utilized at the user's discretion.

### LCD

The LCD (22) will be used to display any or all of the data realized in step #4. Any other relevant information (like power level) may also be displayed here.

### Control Buttons

These are reserved for whatever functions the manufacturer deems necessary. Any or all of these buttons may be used. Additional buttons may be added as needed.

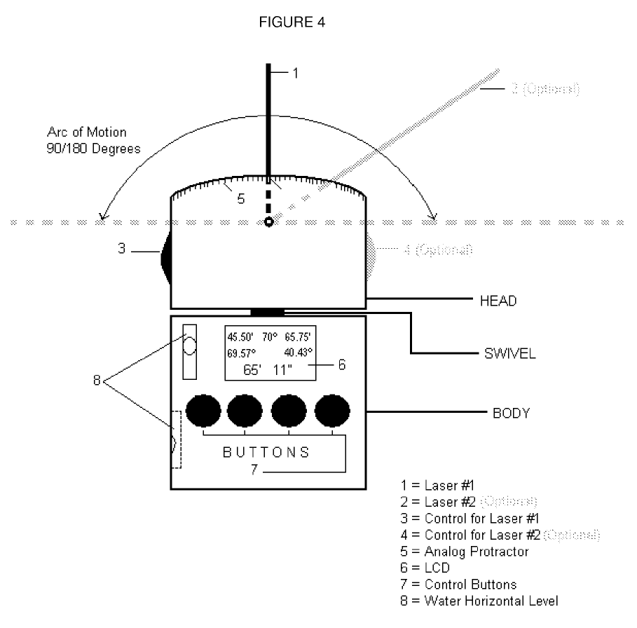

FIG. 4 is a one or two laser(s) (16) on a large head (12), showing them having the capability of rotating 180 degrees.

### Head

The head (12) is the compartment designed to house the lasers and optionally their controls. (FIG. 2 shows the controls placed on the head (12) instead of the body (14).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles.

### Analog Protractor

The optional Analog Protractor (26) will provide an approximate visual reading of the location of the lasers. It must be noted the laser (16) would have already been digitally calibrated in degrees and decimal fractions of such.

### Swivel

The swivel (18) connects the head (12) to the body (14). It also allows the head (12) to rotate in either direction up to a vertical position (90 degrees).

### Body

The body (14) is the compartment designed to house all the other components not placed on or in the head (12). This figure shows the Laser (16) Controls, LCD (22) and Control buttons (24). Other obvious components like microcomputer, power supply etc, although not shown, will be housed here also.

### Laser

The laser (16) is one of the key components of this Laser (16) 3-Point Distance and Angle Calculator. This figure shows the two (2) lasers placed adjacent to each other. These lasers will in some instances be placed one above the other, a decision which will optional to a manufacturer. The laser (16) on the left is able rotate from its leftward-pointing horizontal position, through an arc of 90 degrees, up to the vertical position. The laser (16) on the right is able rotate from its rightward-pointing horizontal position, through an arc of 90 degrees, up to the vertical position. Each laser (16) may be configured to rotate from 0-180 degrees. The same result will/can be achieved in either case.

The function of the lasers are as follows:
(1) The [left Laser (16)] (LL) is rotated (using the left Laser Control (20)) along a calibrated degree scale, and pointed on target number 1 (T1). The degree reading along with the distance to T1 is captured and stored by the Laser (16) 3-Point Distance and Angle Calculator's computing component.
(2) The [right Laser (16)] (RL) is rotated (using the right Laser Control (20)) along a calibrated degree scale, and pointed on target number 1 (T2). The degree reading along with the distance to T2 is captured and stored by the Laser (16) 3-Point Distance and Angle Calculator's computing component.
(3) The angle between T1 and T2 is also captured. For the purpose of this document, this angle is referred to as “O” see FIG. 8). If each laser (16) is made to rotate through an arc of 180 degrees; and, the degree reading for the left laser (16) is greater than that of the right laser (16), then the absolute value for the difference in these two readings will be used in the calculation.
(4) The captured data is then be manipulated and the follow results will be displayed on the LCD (22):
   (a) The distance from your point of origin to T1 (already captured in step #1 above).
   (b) The distance from your point of origin to T2 (already captured in step #2 above).
   (c) The angle at your point of origin between T1 and T2 (already captured in step #3 above).
   (d) The distance between T1 and T2.
   (e) The angle created from your point of origin, to T1 and then to T2. For the purpose of this document, this angle is referred to as “P” (see FIG. 8).
   (f) The angle created from your point of origin, to T2 and then to T1. For the purpose of this document, this angle is referred to as “Q” (see FIG. 8).
   (g) The total distance (perimeter) from point O to T1 to T2.

### Laser Control

The right Laser Control (20) is used to rotate its respective laser (16) through its capable arc. The left Laser Control (20) is used to rotate its respective laser (16) through its capable arc.

### Horizontal Water Level

The Horizontal Water Level (28) is use to determine when the instrument is in a horizontal position. These are placed on both the top and side of the instrument to be utilized at the user's discretion.

### LCD

The LCD (22) will be used to display any or all of the data realized in step #4. Any other relevant information (like power level) may also be displayed here.

### Control Buttons

These are reserved for whatever functions the manufacturer deems necessary. Any or all of these buttons may be used. Additional buttons may be added as needed.

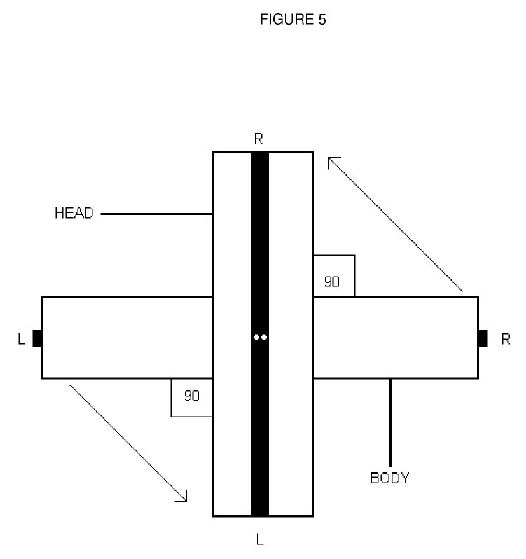

FIG. 5 is a head (12) rotated 90 degrees to the left view, showing the head (12) with two (2) lasers atop each other.

### Head

The head (12) is the compartment designed to house the lasers and optionally their controls. (FIG. 2 shows the controls placed on the head (12) instead of the body (14).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles. The head (12) is shown here in its vertical position, after being rotated 90 degrees to the left.

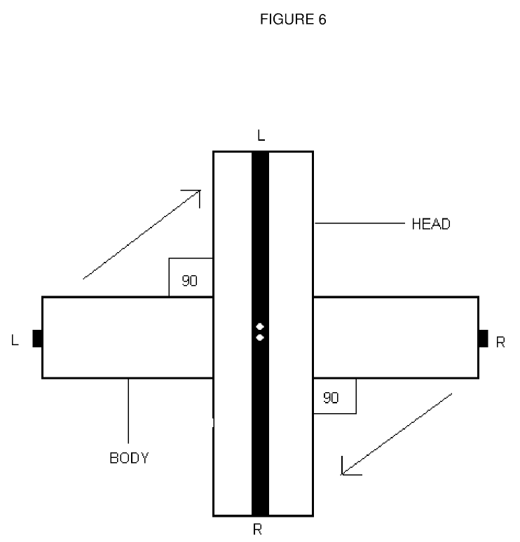

FIG. 6 is a head (12) rotated 90 degrees to the right view, showing the head (12) with two (2) lasers adjacent to each other.

### Head

The head (12) is the compartment designed to house the lasers and optionally their controls. (FIG. 2 shows the controls placed on the head (12) instead of the body (14).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles. The head (12) is shown here in its vertical position, after being rotated 90 degrees to the right.

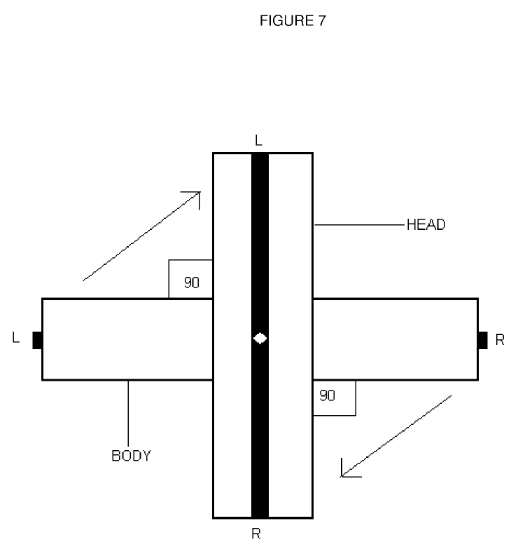

FIG. 7 is a one laser (16)-head (12) rotated to the right view, showing the head (12) with one (1) laser (16), rotated 90 degrees.

### Head

The head (12) is the compartment designed to house the lasers and optionally their controls. (FIG. 2 shows the controls placed on the head (12) instead of the body (14).) The head (12) also has the capability to rotate 90 degrees in either direction up to the vertical position. This capability ensures that the Laser (16) 3-Point Distance and Angle Calculator can be maneuvered to measure horizontal, diagonal and vertical distances and angles. The head (12) is shown here in its vertical position, after being rotated 90 degrees to the right.

### FIG. 8

This figure shows triangular path and area which will be manipulated by the Laser (16) 3-Point Distance and Angle Calculator.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A laser 3-point distance and angle calculator for calculating the distance between your point of reference and any other two points, in any direction; and, calculating the angle between any two objects, comprising:
means for housing the laser(s) and its/their rotating device(s);
means for providing a visual reading of the degree readings and calculated results;
means for housing the laser(s) and its/their rotating device(s);
means for rotating the head 90 degrees in either direction, and connected to said means for housing the laser(s) and its/their rotating device(s);
means for housing all the other components of the instrument, such as LCD, control buttons, laser controls etc, and connected to said means for rotating the head 90 degrees in either direction;
means for pointing to targeted objects, and connected to said means for housing the laser(s) and its/their rotating device(s);
means for rotating laser(s) to the desired position, rigidly connected to said means for housing the laser(s) and its/their rotating device(s);
means for ensuring that the instrument is in a horizontal or vertical position, rigidly inserted to said means for housing all the other components of the instrument, such as LCD, control buttons, laser controls etc;
means for displaying the readings and calculated results, rigidly connected to said means for housing all the other components of the instrument, such as LCD, control buttons, laser controls etc;
and
means for controlling the functionality on the instrument. all four buttons may not be essential or more may be added if necessary, rigidly connected to said means for housing all the other components of the instrument, such as LCD, control buttons, laser controls etc.

2. The laser 3-point distance and angle calculator in accordance with claim 1, wherein said means for housing the laser(s) and its/their rotating device(s) comprises an able to rotate up to 90 degrees in either direction head.

3. The laser 3-point distance and angle calculator in accordance with claim 1, wherein said means for providing a visual reading of the degree reading comprises an analog protractor.

4. The laser 3-point distance and angle calculator in accordance with claim 1, wherein said means for rotating the head 90 degrees in either direction comprises a swivel.

5. The laser 3-point distance and angle calculator in accordance with claim 1, wherein said means for housing all the other components of the instrument, such as LCD, control buttons, laser controls etc comprises a body.

6. The laser 3-point distance and angle calculator in accordance with claim 1, wherein said means for pointing to targeted objects comprises a rotatable from 0-180 degrees laser.

7. The laser 3-point distance and angle calculator in accordance with claim 1, wherein said means for rotating laser(s) to the desired position comprises a laser control.

8. The laser 3-point distance and angle calculator in accordance with claim 1, wherein said means for ensuring that the instrument is in a horizontal or vertical position comprises a levels instrument horizontal water level.

9. The laser 3-point distance and angle calculator in accordance with claim 1, wherein said means for displaying the readings and calculated results comprises a LCD.

10. The laser 3-point distance and angle calculator in accordance with claim 1, wherein said means for controlling the functionality on the instrument. All four buttons may not be essential or more may be added if necessary comprises a control buttons.

11. A laser 3-point distance and angle calculator for calculating the total distance (Perimeter) covered by the triangular path of the beams.

12. A laser 3-point distance and angle calculator for calculating the distance between your point of reference and any other two points, in any direction; and, calculating the angle between any two objects, comprising:
a head (able to rotate up to 90 degrees in either direction), for housing the laser(s) and its/their rotating device(s);
an analog protractor, for providing a visual reading of the degree reading, outwardly engraved to said head;
a swivel, for rotating the head 90 degrees in either direction, and connected to said head;
a body, for housing all the other components of the instrument, such as LCD, control buttons, laser controls etc, and connected to said swivel;
lasers (rotatable from 0-180 degrees), for pointing to targeted objects, and connected to said head;
laser controls, for rotating laser(s) to the desired position, rigidly connected to said head;
an instrument horizontal water level, for ensuring that the instrument is in a horizontal or vertical position, rigidly inserted to said body;
an LCD, for displaying the readings and calculated results, rigidly connected to said body; and
control buttons, for controlling the functionality on the instrument. all four buttons may not be essential or more may be added if necessary, rigidly connected to said body.
